(19) United States
(12) Patent Application Publication
(10) Pub. No.: US 2025/0243359 A1
(43) Pub. Date: Jul. 31, 2025

(54) Resin Composition Including Poly(Lactic-Co-Glycolic Acid) and Film Including the Same

(71) Applicants: SK Innovation Co., Ltd., Seoul (KR); SK Geo Centric Co., Ltd., Seoul (KR)

(72) Inventors: Sang Yeup LEE, Daejeon (KR); Sang Ha SON, Daejeon (KR)

(21) Appl. No.: 19/024,359

(22) Filed: Jan. 16, 2025

(30) Foreign Application Priority Data
Jan. 26, 2024 (KR) 10-2024-0012687

(51) Int. Cl. C08L 67/04; C08J 5/18

(52) U.S. Cl. CPC C08L 67/04; C08J 5/18; C08J 2367/04; C08J 2423/08; C08L 2203/16; C08L 2205/025; C08L 2205/03

(57) ABSTRACT

A poly(lactic-co-glycolic acid)-containing resin composition according to exemplary embodiments may include a poly(lactic-co-glycolic acid) (PLGA) polymer, a zinc-containing ionomer (Zn ionomer) and an ethylene terpolymer. The PLGA polymer may be 65 wt % or more and less than 100 wt % based on a total weight of the poly(lactic-co-glycolic acid)-containing resin composition.

### CROSS-REFERENCE TO RELATED APPLICATION

This application claims priority to Korean Patent Application No. 10-2024-0012687 filed Jan. 26, 2024, the disclosure of which is hereby incorporated by reference in its entirety.

### BACKGROUND

### Technical Field

The present disclosure relates to a resin composition comprising poly(lactic-co-glycolic acid) and a film comprising the same, and in some non-limiting embodiments, to a resin composition comprising a blend of a poly(lactic-co-glycolic acid)-containing resin and a film comprising the same.

Technical Considerations A biodegradable resin is a resin that can be decomposed by other organic organisms such as bacteria, microorganisms, etc. Due to strengthened environmental regulations according to the worsening of environmental pollution caused by existing non-decomposable polymers, demand for the biodegradable resin as a substitute for a non-decomposable resin is increasing. In addition, the biodegradable resin has recently been utilized in various industrial fields such as a packaging industry, electronics industry, automobile industry, building materials industry, marine industry, stationery industry, pulp and paper industry, etc.

Examples of the biodegradable resin may comprise poly(glycolic acid) (PGA), poly(butylene succinate) (PBS), polyhydroxyalkanoate (PHA), polylactic acid (PLA), poly(lactic-co-glycolic acid) (PLGA), etc. Among them, PLGA is a synthetic resin produced by copolymerization of a glycolic acid monomer and a lactic acid monomer, and has excellent biodegradability, as well as excellent gas barrier properties as a resin having a linear structure.

In addition, the PLGA resin comprises an ester bond therein, and has excellent mechanical strength and high brittleness due to high crystallinity. Therefore, attempts to develop a barrier film having high gas barrier properties, excellent biodegradability, and durability using the PLGA resin are being conducted.

However, the PLGA resin has problems that it is difficult to maintain a film structure due to excessively high biodegradability, and it is also difficult to mass produce due to the high price thereof.

### SUMMARY

An object of the present disclosure is to provide a resin composition comprising poly(lactic-co-glycolic acid) which provides improved barrier properties.

Another object of the present disclosure is to provide a film formed from the resin composition and having improved barrier properties.

To achieve the above objects, according to a non-limiting aspect of the present disclosure, there is provided a resin composition comprising poly(lactic-co-glycolic acid) (“poly(lactic-co-glycolic acid)-containing resin composition”), which comprises: a poly(lactic-co-glycolic acid) (PLGA) polymer; a zinc-containing ionomer; and an ethylene terpolymer, wherein the PLGA polymer is 65% by weight or more and less than 100% by weight based on a total weight of the poly(lactic-co-glycolic acid)-containing resin composition.

In some non-limiting embodiments, the zinc-containing ionomer may comprise a terpolymer of ethylene, zinc (meth)acrylate and (meth)acrylic acid.

In some non-limiting embodiments, the ethylene terpolymer may comprise a copolymer of ethylene, glycidyl (meth)acrylate and alkyl (meth)acrylate.

In some non-limiting embodiments, a content of the PLGA polymer may be 65% by weight to 98% by weight based on the total weight of the poly(lactic-co-glycolic acid)-containing resin composition.

In some non-limiting embodiments, a content of the zinc-containing ionomer may be 1% by weight to 34% by weight based on the total weight of the poly(lactic-co-glycolic acid)-containing resin composition.

In some non-limiting embodiments, a content of the ethylene terpolymer may be 1% by weight to 34% by weight based on the total weight of the poly(lactic-co-glycolic acid)-containing resin composition.

In some non-limiting embodiments, a sum of the content of the zinc-containing ionomer and the content of the ethylene terpolymer may be 2% by weight to 35% by weight based on the total weight of the poly(lactic-co-glycolic acid)-containing resin composition.

In some non-limiting embodiments, a content of the ethylene terpolymer may be the same as the content of the zinc-containing ionomer or more in the total weight of the poly(lactic-co-glycolic acid)-containing resin composition.

In some non-limiting embodiments, a melt viscosity of the poly(lactic-co-glycolic acid)-containing resin composition measured under conditions of 230° C., 5% strain, and 0.1 Hz frequency may be 500 Pa·s to 20,000 Pa·s.

In some non-limiting embodiments, a melt flow index of the poly(lactic-co-glycolic acid)-containing resin composition measured under conditions of 230° C. and 2.16 kg load may be 1 g/10 min to 100 g/10 min.

According to another non-limiting aspect of the present disclosure, there is provided a film formed from the resin composition comprising poly(lactic-co-glycolic acid).

In some non-limiting embodiments, the film may have a thickness of 100 μm to 300 μm.

In some non-limiting embodiments, an oxygen transmittance rate of the film measured at a relative humidity of 0% and a temperature of 25° C. may be 50 g/m²·day or less.

In some non-limiting embodiments, a mass reduction rate of the film calculated according to Equation 1 below may be 5% to 85%.

$$Mass reduction rate ( \% ) = \frac{{W}_{i} - {W}_{f}}{{W}_{i}} \times 100 \qquad [ Equation 1 ]$$

In Equation 1, Wᵢ is an initial mass (g) of the film, and W_{f} is a mass (g) of the film measured after the film is left in soil under composting conditions according to ISO 20200 for 6 months.

In some non-limiting embodiments, an oxygen transmittance rate of the film may satisfy Equation 2 below.

$$OTR ( PLGA - Poly ) < 0.1 ( x \cdot OTR ( PLGA ) + ( 1 - x ) \cdot OTR ( Poly ) ) \qquad [ Equation 2 ]$$

In Equation 2, OTR (PLGA-Poly) is the oxygen transmittance rate of the film formed from the poly(lactic-co-glycolic acid)-containing resin composition, OTR (PLGA) is an oxygen transmittance rate of a film including only poly(lactic-co-glycolic acid), OTR (Poly) is an oxygen transmittance rate of a film including only a resin including a zinc-containing ionomer or an ethylene terpolymer, and x is in a range of 0.65≤x<1.

In some non-limiting embodiments, the resin may comprise a poly(lactic-co-glycolic acid) (PLGA) polymer. Accordingly, the resin composition may have improved biodegradability. In addition, since the resin composition may comprise an additional component other than the PLGA polymer, the resin composition may have improved structural stability.

In some non-limiting embodiments, the film may comprise the PLGA-containing resin composition. Accordingly, a gas permeation path inside the film may become complex, such that the gas transmittance may be reduced, and the biodegradability and environmental friendliness may be improved due to the PLGA polymer comprised in the film.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a graph illustrating measured values of an oxygen transmittance rate and estimated values of the oxygen transmittance rate of a film according to exemplary and non-limiting embodiments;

FIGS. 2A, 3A and 4A are photographs of films according to exemplary examples and comparative examples; and

FIGS. 2B, 3B and 4B are photographs illustrating a degree of biodegradation when the films according to exemplary examples and comparative examples are left in soil under composting conditions.

### DETAILED DESCRIPTION

According to some exemplary and non-limiting embodiments, a poly(lactic-co-glycolic acid)-containing resin composition which comprises a poly(lactic-co-glycolic acid) (PLGA) polymer, a zinc ionomer (ZnIO) and an ethylene terpolymer, and a film comprising the poly(lactic-co-glycolic acid)-containing resin composition are provided.

Hereinafter, the present disclosure will be described in detail through embodiments with reference to the accompanying drawings. However, the embodiments are merely illustrative and the present disclosure is not limited to the specific embodiments described by way of example.

Furthermore, throughout the disclosure, unless otherwise particularly stated, the word “comprise”, “include”, “contain”, or “have” does not mean the exclusion of any other constituent element, but means further inclusion of other constituent elements, and elements, materials, or processes which are not further listed are not excluded.

Unless the context clearly indicates otherwise, the singular forms of the terms used in the present specification may be interpreted as including the plural forms. As used herein, the singular form of “a”, “an”, and “the” include plural referents unless the context clearly states otherwise.

The numerical range used in the present disclosure comprises all values within the range comprising the lower limit and the upper limit, increments logically derived in a form and spanning in a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present disclosure. Unless otherwise defined in the present disclosure, values which may be outside a numerical range due to experimental error or rounding off of a value are also comprised in the defined numerical range.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Hereinafter, unless otherwise particularly defined in the present disclosure, “about” may be considered as a value within 30%, 25%, 20%, 15%, 10%, 5%, 3%, 2%, 1%, 0.5%, 0.1%, 0.05% or 0.01% of a stated value. Unless indicated to the contrary, the numerical parameters set forth in this disclosure are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used herein, “formed from” or “prepared from” denotes open, e.g., “comprising,” claim language. As such, it is intended that a composition “formed from” or “prepared from” a list of recited components be a composition comprising at least these recited components or the reaction product of at least these recited components, and can further comprise other, non-recited components, during the composition's formation or preparation.

According to some non-limiting embodiments, the poly(lactic-co-glycolic acid)-containing resin composition may comprise a PLGA polymer, ZnIO and ethylene terpolymer.

The PLGA polymer is a copolymer of a glycolic acid monomer and a lactic acid monomer. Since the lactic acid monomer is introduced into the PLGA polymer, it has lower brittleness and higher flexibility than the poly(glycolic acid). Accordingly, the PLGA polymer may have high biodegradability and workability. In addition, the PLGA polymer may have crystallinity due to an ester bond of the glycolic acid. Thereby, the resin composition comprising the PLGA polymer may have improved gas barrier properties.

The “PLGA” or “poly(lactic-co-glycolic acid)” of the present specification may be a compound referred to as poly(glycolic acid-co-lactic acid) (PGLA).

The ZnIO is a type of a polymer comprising zinc of a transition metal, and has low hygroscopic property and moisture content. Thus, the poly(lactic-co-glycolic acid)-containing resin composition may have improved structural stability due to a coordination bonding with an ester group of the PLGA polymer.

The ethylene terpolymer is a polymer in which three basic monomers comprising a monomer derived from ethylene are copolymerized, and may have improved structural stability due to crosslinking formed between the PLGA polymer and the ZnIO.

In some non-limiting embodiments, the ZnIO may comprise a terpolymer of ethylene, zinc (meth)acrylate and (meth)acrylic acid (“ethylene-zinc (meth)acrylate-(meth)acrylic acid terpolymer”).

The ethylene-zinc (meth)acrylate-(meth)acrylic acid terpolymer is a polymer comprising a structure in which a zinc ion (Zn²⁺) is ionically bonded to a carboxylate anion (—COO⁻). The zinc ion of the ethylene-zinc (meth)acrylate-(meth)acrylic acid terpolymer is a transition metal ion, and may form a coordination bond with the ester group of the PLGA polymer. Accordingly, the ethylene-zinc (meth)acrylate-(meth)acrylic acid terpolymer may be comprised in the poly(lactic-co-glycolic acid)-containing resin composition, thereby improving the durability and melt strength.

In some non-limiting embodiments, the content of an ethylene monomer in the ethylene-zinc (meth)acrylate-(meth)acrylic acid terpolymer is not limited, but may be, for example, 70% by weight (“wt %”) to 98 wt %, 73 wt % to 95 wt %, or 76 wt % to 92 wt % based on a total weight of the ethylene-zinc (meth)acrylate-(meth)acrylic acid terpolymer.

In some non-limiting embodiments, the content of a zinc (meth)acrylate monomer in the ethylene-zinc (meth)acrylate-(meth)acrylic acid terpolymer is not limited, but may be, for example, 1 wt % to 20 wt %, 1 wt % to 17 wt %, or 1 wt % to 14 wt % based on the total weight of the ethylene-zinc (meth)acrylate-(meth)acrylic acid terpolymer.

In some non-limiting embodiments, the content of a (meth)acrylic acid monomer in the ethylene-zinc (meth)acrylate-(meth)acrylic acid terpolymer is not limited, but may be, for example, 1 wt % to 29 wt %, 4 wt % to 26 wt %, or 7 wt % to 23 wt % based on the total weight of the ethylene-zinc (meth)acrylate-(meth)acrylic acid terpolymer.

In some non-limiting embodiments, the ethylene terpolymer may comprise a copolymer of ethylene, glycidyl (meth)acrylate and alkyl (meth)acrylate (hereinafter, EAG). For example, the ethylene terpolymer may comprise a copolymer of ethylene, glycidyl methacrylate and alkyl acrylate.

The EAG is an ethylene polymer comprising a glycidyl group. The glycidyl group is comprised in the poly(lactic-co-glycolic acid)-containing resin composition, and may be bonded to a carboxyl group of at least one of the PLGA polymer and ZnIO.

Accordingly, the poly(lactic-co-glycolic acid)-containing resin composition may be extended, and the polymer structure may become complex (for example, a branched structure, a network structure, etc.). Therefore, the poly(lactic-co-glycolic acid)-containing resin composition may have improved melt strength, durability and the workability.

In some non-limiting embodiments, the content of the ethylene monomer in the EAG is not limited, but may be, for example, 50 wt % to 88 wt %, 55 wt % to 82 wt %, or 57 wt % to 78 wt % based on the total weight of the EAG.

In some non-limiting embodiments, the content of a glycidyl (meth)acrylate monomer in the EAG is not limited, but may be, for example, 1 wt % to 30 wt %, 3 wt % to 25 wt %, or 5 wt % to 20 wt % based on the total weight of the EAG.

In some non-limiting embodiments, the content of an alkyl (meth)acrylate monomer in the EAG is not limited, but may be, for example, 10 wt % to 48 wt %, 15 wt % to 42 wt %, or 17 wt % to 38 wt % based on the total weight of the EAG.

In some non-limiting embodiments, the content of the PLGA polymer may exceed 65 wt % and less than 100 wt % based on a total weight of the poly(lactic-co-glycolic acid)-containing resin composition.

When the content of the PLGA polymer is less than 65 wt % based on the total weight of the poly(lactic-co-glycolic acid)-containing resin composition, the biodegradability by the PLGA polymer may be decreased. As the content of the PLGA polymer is decreased, the crystallinity of the poly(lactic-co-glycolic acid) may be reduced, thereby the gas barrier properties may be decreased When the poly(lactic-co-glycolic acid)-containing resin composition is formed only of the PLGA polymer, the biodegradability may be excessively good. Accordingly, when the poly(lactic-co-glycolic acid)-containing resin composition is used as a packaging material, etc., self-decomposition may occur during the delivery process, such that the stability may be decreased.

In some non-limiting embodiments, the content of the PLGA polymer may be 65 wt % to 98 wt %, 65 wt % to 93 wt %, 65 wt % to 90 wt %, or 65 wt % to 88 wt % based on the total weight of the poly(lactic-co-glycolic acid)-containing resin composition.

Within the above content range, the PLGA polymer may be distributed throughout an entire area of the poly(lactic-co-glycolic acid)-containing resin composition. Accordingly, the poly(lactic-co-glycolic acid)-containing resin composition may have improved biodegradability, and additional components other than the PLGA polymer may be sufficiently added to the resin composition, thereby improving the structural stability. Accordingly, melt strength, durability, and workability may be improved while maintaining low gas transmittance rate.

In some non-limiting embodiments, the content of the PLGA polymer may be 65 wt % to 85 wt %, 68 wt % to 85 wt %, 70 wt % to 85 wt %, or 70 wt % to 80 wt % based on the total weight of the poly(lactic-co-glycolic acid)-containing resin composition. Within the above content range, the biodegradability, durability and workability of the poly(lactic-co-glycolic acid)-containing resin composition may be further improved.

In some non-limiting embodiments, the content of the ZnIO may be 1 wt % to 34 wt %, 2 wt % to 33 wt %, 5 wt % to 30 wt %, or 5 wt % to 28 wt % based on the total weight of the poly(lactic-co-glycolic acid)-containing resin composition.

Within the above content range, while preventing the gas transmittance rate from decreasing due to an increase of the ZnIO and a decrease of the PLGA polymer, the zinc ion of the ZnIO may form a coordination bond with the ester group of the PLGA polymer, thereby improving the structural stability and durability. In some non-limiting embodiments, the hygroscopic property is reduced, such that it is possible to prevent the polymer structure from collapsing due to the high biodegradability of the poly(lactic-co-glycolic acid)-containing resin composition.

In some non-limiting embodiments, the content of the ZnIO may be 5 wt % to 25 wt %, 5 wt % to 20 wt %, 10 wt % to 20 wt %, or 10 wt % to 15 wt % based on the total weight of the poly(lactic-co-glycolic acid)-containing resin composition. Within the above content range, the structural stability and durability of the poly(lactic-co-glycolic acid)-containing resin composition may be further improved.

In some non-limiting embodiments, the content of the ethylene terpolymer (e.g., EAG) may be 1 wt % to 34 wt %, 2 wt % to 33 wt %, 5 wt % to 30 wt %, or 5 wt % to 28 wt % based on the total weight of the poly(lactic-co-glycolic acid)-containing resin composition.

Within the above content range, the ethylene terpolymer (e.g., EAG) may be crosslinked with the carboxyl group of the PLGA polymer and the ZnIO, such that the melt strength and workability of the poly(lactic-co-glycolic acid)-containing resin composition may be further improved.

In some non-limiting embodiments, the content of the ethylene terpolymer (e.g., EAG) may be 5 wt % to 25 wt %, 5 wt % to 20 wt %, 5 wt % to 15 wt %, or 10 wt % to 15 wt % based on the total weight of the poly(lactic-co-glycolic acid)-containing resin composition. Within the above content range, the melt strength and workability of the poly(lactic-co-glycolic acid)-containing resin composition may be further improved.

In some non-limiting embodiments, the content of the ethylene terpolymer (e.g., EAG) in the total weight of the poly(lactic-co-glycolic acid)-containing resin composition may be the same as the content of the ZnIO or more. Accordingly, the melt flow index of the poly(lactic-co-glycolic acid)-containing resin composition may be appropriately reduced without deteriorating the biodegradability thereof. Therefore, the workability of the poly(lactic-co-glycolic acid)-containing resin composition may be improved, thereby facilitating to manufacture the film.

In some non-limiting embodiments, the content of the ethylene terpolymer (e.g., EAG) in the total weight of the poly(lactic-co-glycolic acid)-containing resin composition may be the same as the content of the ZnIO or more. Accordingly, the workability of the poly(lactic-co-glycolic acid)-containing resin may be further improved.

As described above, the melt viscosity and melt flow index may be controlled by adjusting the contents of the PLGA polymer, ZnIO and ethylene terpolymer comprised in the poly(lactic-co-glycolic acid)-containing resin composition.

In some non-limiting embodiments, a melt viscosity of the poly(lactic-co-glycolic acid)-containing resin composition may be 500 Pa·s to 20,000 Pa·s, 1,000 Pa·s to 18,000 Pa·s, 1,500 Pa·s to 15,000 Pa·s, 1,500 Pa·s to 12,000 Pa·s, 1,500 Pa·s to 8,000 Pa·s, or 2,000 Pa·s to 8,000 Pa·s.

The melt viscosity is a value measured at a strain of 5% and a frequency of 0.1 Hz on a specimen prepared by pressing the poly(lactic-co-glycolic acid)-containing resin composition to a thickness of 2 mm at 230° C.

In some non-limiting embodiments, the melt flow index of the poly(lactic-co-glycolic acid)-containing resin composition may be 1 g/10 min to 100 g/10 min, 10 g/10 min to 100 g/10 min, 10 g/10 min to 80 g/10 min, 15 g/10 min to 60 g/10 min, or 20 g/10 min to 60 g/10 min.

The melt flow index is a value measured by a mass (g) in which the poly(lactic-co-glycolic acid)-containing resin composition moves for 10 minutes under conditions of a temperature of 230° C. and a load of 2.16 kg.

When the melt viscosity and melt flow index are maintained within the above ranges, the poly(lactic-co-glycolic acid)-containing resin composition may have improved flexibility and structural stability compared to the PLGA polymer. Therefore, for example, workability may be improved in processing such as foaming-expansion molding, injection molding, compression molding, casting film molding, and/or inflation film molding processes. Accordingly, workability from the poly(lactic-co-glycolic acid)-containing resin composition to the film may be improved.

The above-described poly(lactic-co-glycolic acid)-containing resin composition may be formed by drying and kneading a mixture of the PLGA polymer, ZnIO and ethylene terpolymer.

In some non-limiting embodiments, the PLGA polymer, ZnIO and ethylene terpolymer may be introduced into a hopper dryer.

The PLGA polymer and ZnIO may be introduced into the hopper dryer maintained at a temperature condition of, for example, 60° C. to 100° C., 70° C. to 90° C., or 75° C. to 85° C. and dried. The ethylene terpolymer (e.g., EAG) may be introduced into the hopper dryer maintained at a temperature condition of, for example, 20° C. to 60° C., 30° C. to 50° C., or 35° C. to 45° C. and dried.

The PLGA polymer, ZnIO and ethylene terpolymer may be dried for, for example, 10 hours to 14 hours, 11 hours to 13 hours, or 11.5 hours to 12.5 hours. Within the above range, the PLGA polymer, ZnIO and ethylene terpolymer may be sufficiently dried such that side reactions in the kneading process of the PLGA polymer, ZnIO and ethylene terpolymer may be suppressed.

The dried PLGA polymer, ZnIO and ethylene terpolymer may be introduced into a chamber of an internal mixer. The chamber of the internal mixer may be maintained at, for example, 210° C. to 250° C., 220° C. to 240° C., or 225° C. to 235° C.

When the dried PLGA polymer, ZnIO and ethylene terpolymer are introduced into the internal mixer, a rotor inside the internal mixer may rotate at a rotation speed of, for example, 10 rpm to 70 rpm, 20 rpm to 60 rpm, or 30 rpm to 50 rpm.

Within the above range, kneading may be initiated while preventing the PLGA polymer, ZnIO and ethylene terpolymer from being agglomerated with each other.

After the introduction of the dried PLGA polymer, ZnIO and ethylene terpolymer is completed, kneading may be performed while the rotation speed of the rotor may be maintained at, for example, 60 rpm to 100 rpm, 70 rpm to 90 rpm, or 75 rpm to 85 rpm. The kneading may be performed for, for example, 1 minute to 5 minutes, 2 minutes to 4 minutes, or 2.5 minutes to 3.5 minutes.

Within the above speed and time ranges, the PLGA polymer, ZnIO and ethylene terpolymer may be uniformly distributed to complete kneading.

As described above, the kneaded product may be recovered to obtain the poly(lactic-co-glycolic acid)-containing resin composition.

Although the above-described kneading process has been described as being performed with the internal mixer, the kneading process is not limited to the case of being performed with the internal mixer. For example, the dried PLGA polymer, ZnIO and ethylene terpolymer may be introduced into a single-screw extruder or a twin-screw extruder, followed by performing melting and kneading to complete the kneading. The resin composition that has been kneaded and discharged through a discharge port of the single-screw extruder or twin-screw extruder may be cut in a pelletizer to obtain the poly(lactic-co-glycolic acid)-containing resin composition in the form of pellets.

According to some non-limiting embodiments, a film may be formed from the above-described poly(lactic-co-glycolic acid)-containing resin composition. Accordingly, the gas transmittance (e.g., the oxygen transmittance) of the film may be reduced, and the biodegradability and durability may be improved.

In some non-limiting embodiments, the film may have a thickness of 100 m to 300 m, 150 m to 300 m, or 150 m to 250 m. Within the above range, the gas transmittance to the film may be sufficiently reduced.

In some non-limiting embodiments, the oxygen transmittance of the film may be 50 g/m² day or less, 25 g/m² day or less, 10 g/m² day or less, 5 g/m² day or less, or 1 g/m² day or less. The lower limit of the oxygen transmittance of the film is not limited, but for example, the oxygen transmittance of the film may exceed 0 g/m²·day, 0.1 g/m²·day or more, 0.2 g/m²·day or more, or 0.5 g/m²·day or more.

The oxygen transmittance may be measured under a relative humidity condition of 0% and a temperature condition of 25° C.

Within the above oxygen transmittance range, when the film is used as a barrier film, the barrier property against gas (e.g., oxygen) is improved, such that a product contained in the barrier film may be sufficiently protected.

When the PLGA polymer comprised in the poly(lactic-co-glycolic acid)-containing resin composition is comprised in an amount of 65 wt % to 98 wt %, the PLGA polymer may be uniformly arranged over the entire area of the poly(lactic-co-glycolic acid)-containing resin composition. In some non-limiting examples, the structural stability may be improved through a material other than the PLGA polymer. Accordingly, the high biodegradability of the PLGA polymer and the biodegradability of the film comprising the poly(lactic-co-glycolic acid)-containing resin composition may be appropriately maintained by the material other than the PLGA polymer (e.g., the ZnIO, ethylene terpolymer, etc.).

In some non-limiting embodiments, a mass reduction rate of the film calculated according to Equation 1 below may be 5% to 85%, 5% to 80%, 5% to 75%, or 8% to 73%.

$$Mass reduction rate ( \% ) = \frac{{W}_{i} - {W}_{f}}{{W}_{i}} \times 100 \qquad [ Equation 1 ]$$

In Equation 1, Wᵢ is an initial mass (g) of the film, and W_{f} is a mass (g) of the film measured after the film is left in soil under composting conditions according to ISO 20200 for 6 months.

Within the mass reduction rate range, the biodegradability of the film may not be excessively high, such that the film may be appropriately formed, and the formed film may be used as a packaging material. For example, when the film is used as the packaging material, it may not be decomposed during the distribution process, etc.

The poly(lactic-co-glycolic acid)-containing resin composition may comprise the PLGA polymer in an amount of 65 wt % or more, such that the oxygen transmittance of the poly(lactic-co-glycolic acid)-containing resin composition may be maintained low. For example, the oxygen transmittance of the poly(lactic-co-glycolic acid)-containing resin composition may be measured lower than an arithmetic mean value of the oxygen transmittance of each of the polymer components contained in the poly(lactic-co-glycolic acid)-containing resin composition.

In some non-limiting embodiments, an oxygen transmittance rate of the film may satisfy Equation 2 below.

$$OTR ( PLGA - Poly ) < 0.1 ( x \cdot OTR ( PLGA ) + ( 1 - x ) \cdot OTR ( Poly ) ) \qquad [ Equation 2 ]$$

In Equation 2 above, OTR (PLGA-Poly) is the oxygen transmittance rate of the film formed from the poly(lactic-co-glycolic acid)-containing resin composition, OTR (PLGA) is an oxygen transmittance rate of the film including only poly(lactic-co-glycolic acid), OTR (Poly) is an oxygen transmittance rate of a film including only a resin including a zinc-containing ionomer or an ethylene terpolymer, and x is in a range of 0.65≤x<1.

The film may be provided as a barrier film for packaging materials of various products, for example, a packaging material for packaging food, a packaging material for packaging a battery and the like.

The above-described film may be manufactured from the poly(lactic-co-glycolic acid)-containing resin composition.

According to some non-limiting embodiments, the poly(lactic-co-glycolic acid)-containing resin composition may be pressed through a press to manufacture the film.

In some non-limiting embodiments, the press may be maintained at a temperature of 200° C. to 260° C., 210° C. to 250° C., 220° C. to 240° C., or 225° C. to 235° C. Within the above range, the film comprising the poly(lactic-co-glycolic acid)-containing resin composition may be formed and deformed.

In some non-limiting embodiments, the poly(lactic-co-glycolic acid)-containing resin composition may be pressed at a pressure of 10 MPa to 30 MPa, 15 MPa to 25 MPa, or 18 MPa to 22 MPa for 1 minute to 3 minutes, or 1.5 minutes to 2.5 minutes.

Within the above range, the film may be manufactured to have the above-described thickness. Accordingly, a film having a thin thickness with reduced oxygen transmittance may be manufactured.

The above-described film preparation has been described as the case of being manufactured by pressing the resin composition through the press, but the film manufacturing method is not limited thereto. For example, the poly(lactic-co-glycolic acid)-containing resin composition melted in the extruder may be extruded from a T-die to a chill roll and cooled, to manufacture the film (for example, a casting film manufacturing method). For example, the poly(lactic-co-glycolic acid)-containing resin composition may be cooled by air contact through an air ring in a ring-shaped die (for example, a spiral die, etc.) to manufacture the film (for example, a blown film manufacturing method).

Hereinafter, experimental examples comprising specific examples and comparative examples are proposed to facilitate understanding of the present disclosure. However, the following examples are only given for illustrating the present disclosure and are not intended to limit the appended claims. It will be apparent those skilled in the art that various alterations and modifications are possible within the scope and spirit of the present disclosure.

### Examples and Comparative Examples

### Example 1

### (1) Preparation of Raw Material for Poly(Lactic-Co-Glycolic Acid)-Containing Resin Composition

Poly(lactic-co-glycolic acid) (PLGA) was dried in a hopper dryer set to 80° C. for 12 hrs to prepare a dried PLGA.

A terpolymer of ethylene, zinc acrylate and acrylic acid was dried in the hopper dryer set to 80° C. for 12 hrs to prepare a dried terpolymer of ethylene, zinc acrylate and acrylic acid.

Contents of ethylene monomer, zinc acrylate monomer, and acrylic acid monomer in the terpolymer of ethylene, zinc acrylate and acrylic acid were about 86.4 wt %, 6.8 wt %, and 6.8 wt %, respectively.

The terpolymer (EAG) of ethylene, glycidyl methacrylate and methyl acrylate was dried in the hopper dryer set at 40° C. for 12 hrs to prepare a dried EAG. The contents of ethylene monomer, glycidyl methacrylate monomer and methyl acrylate monomer in the EAG were 68 wt %, 8 wt % and 24 wt %, respectively.

Mitsui hot air dryer was used as the hopper dryer.

### (2) Preparation of Poly(Lactic-Co-Glycolic Acid)-Containing Resin Composition

The dried PLGA, the dried terpolymer of ethylene and zinc acrylate acrylic acid, and the dried EAG were introduced into a chamber of an internal mixer at a ratio of 80 wt %, 10 wt % and 10 wt %, respectively. A temperature inside the chamber of the internal mixer was maintained at 230° C., and a rotor of the internal mixer rotated at a speed of 40 rpm.

Thereafter, the speed of the rotor was increased to 80 rpm, and kneading was performed for 3 minutes, and then a poly(lactic-co-glycolic acid)-containing resin composition as a kneading product was prepared and recovered.

Brabender Measuring Mixer W50 was used as the internal mixer.

### (3) Manufacturing of Film

The poly(lactic-co-glycolic acid)-containing resin composition was pressed at a pressure of 20 MPa for 2 minutes using a press set to 230° C. to manufacture a film.

### Examples 2 to 5 and Comparative Examples 1 to 9

Poly(lactic-co-glycolic acid)-containing resin compositions and films of Examples 2 to 5 and Comparative Examples 1 to 9 were manufactured according to the same procedures as described in Example 1, except that the types of PLGA used and the weight ratios of the dried PLGA, the dried ethylene, the terpolymer of zinc acrylate and acrylic acid, and the dried EAG to be introduced into the chamber of the internal mixer were adjusted as shown in Table 1 below.

TABLE 1

| | | Copolymer of | |
|---|---|---|---|
| | PLGA | ethylene and zinc | |
| | Content | (meth)acrylate | EAG |
| | (wt %) | (wt %) | (wt %) |
| Example 1 | 80 | 10 | 10 |
| Example 2 | 70 | 15 | 15 |
| Example 3 | 65 | 10 | 25 |
| Example 4 | 65 | 20 | 15 |
| Example 5 | 90 | 5 | 5 |
| Comparative example 1 | 65 | 0 | 32 |
| Comparative example 2 | 65 | 35 | 0 |
| Comparative example 3 | 60 | 20 | 20 |
| Comparative example 4 | 60 | 10 | 30 |
| Comparative example 5 | 60 | 30 | 10 |
| Comparative example 6 | 50 | 25 | 25 |
| Comparative example 7 | 100 | 0 | 0 |
| Comparative example 8 | 0 | 100 | 0 |
| Comparative example 9 | 0 | 0 | 100 |

### Experimental Example 1

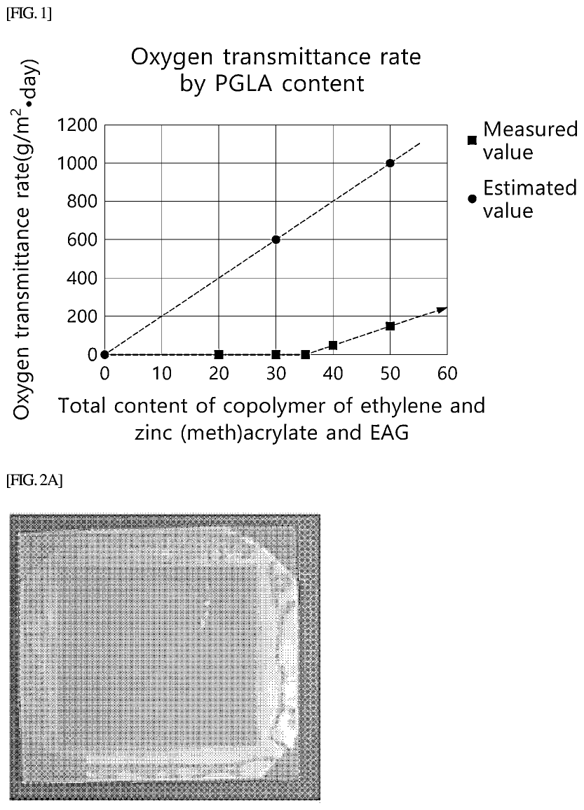

FIG. 1 is a graph illustrating measured values and estimated values of the oxygen transmittance rate of the film according to a sum of the content of the terpolymer of ethylene, zinc acrylate and acrylic acid included in the poly(lactic-co-glycolic acid)-containing resin composition and the content of EAG.

The estimated value of the oxygen transmittance rate represents a value obtained by calculating an arithmetic average of the oxygen transmittance rate of PLGA, the oxygen transmittance rate of the terpolymer of ethylene, zinc acrylate and acrylic acid, and the oxygen transmittance rate of EAG included in the poly(lactic-co-glycolic acid)-containing resin composition according to the weight ratio.

The measured value of the oxygen transmittance rate represents a value obtained by measuring the oxygen transmittance rate of the film including the poly(lactic-co-glycolic acid)-containing resin composition. The measured values of Examples 1, 2 and 3, and Comparative Examples 3 and 6 were used as the measured values of the oxygen transmittance rate of the film.

Referring to FIG. 1, the estimated values of the oxygen transmittance rate of the film were calculated to increase linearly according to the sum of the content of the terpolymer of ethylene, zinc acrylate and acrylic acid and the content of EAG.

However, in the case of the oxygen transmittance rate measured values of the film, when the sum of the content of the terpolymer of ethylene, zinc acrylate and acrylic acid and the content of EAG was 35 wt % or less (PLGA exceeded 65 wt %) based on the total weight of the film, the oxygen transmittance rate was maintained low. In addition, when the sum of the content of the terpolymer of ethylene, zinc acrylate and acrylic acid and the content of EAG exceeded 35 wt % based on the total weight of the film, the oxygen transmittance rate was measured to increase in proportion to the contents.

### Experimental Example 2

### (1) Measurement of Melt Viscosity

The poly(lactic-co-glycolic acid)-containing resin compositions prepared according to the above-described examples and comparative examples were pressed to a thickness of 2 mm at a temperature condition of 230° C., and then melt viscosities were measured using a viscometer (TA ARES).

The viscosity meter was set under conditions of 230° C., 5% strain, and 0.1 Hz to 500 Hz frequency, and the viscosity value measured at a frequency of 0.1 Hz was determined as the melt viscosity.

### (2) Measurement of Melt Flow Index

The melt flow indexes of the poly(lactic-co-glycolic acid)-containing resin compositions prepared according to the above-described examples and comparative examples were measured under a temperature condition of 230° C. and a load condition of 2.16 kg according to ASTM D1238.

### (3) Measurement of Oxygen Transmittance Rate

The films manufactured according to the above-described examples and comparative examples were mounted on an oxygen transmittance rate meter (MOCON OX TRANS model 2/61) to measure oxygen transmittance rates.

The oxygen transmittance rate was measured as a value of a point where the transmittance was stabilized after measuring for 12 hours under a relative humidity condition of 0% and a temperature condition of 25° C.

The upper limit of the oxygen transmittance rate measured value was 1,200 g/m²·day, and the oxygen transmittance rate of the film that exceeded the upper limit and was not measured is indicated as ‘Exceeded’ in Table 2.

### (4) Measurement of Mass Reduction Rate—Evaluation of Biodegradability

The films manufactured according to the above-described examples and comparative examples were cut into a size of 5 cm in width and 5 cm in length, and masses (Wᵢ) of the cut films were measured.

Then, after the films were left in soil under composting conditions according to ISO 20200 for 6 months, masses (W_{f}) were measured.

The mass reduction rate was calculated using Equation 1 below using the measured mass (Wᵢ) of the cut film and the mass (W_{f}) after leaving the same.

$$Mass reduction rate ( \% ) = \frac{{W}_{i} - {W}_{f}}{{W}_{i}} \times 100 \qquad [ Equation 1 ]$$

As the soil under composting conditions, soil including 40 wt % of sawdust, 30 wt % of rabbit feed, 10 wt % of ripened compost, 10 wt % of corn starch, 5 wt % of saccharose, 4 wt % of cornseed oil, and 1 wt % of urea was used.

Evaluation results are shown in Table 2 below.

TABLE 2

| | Melt | Melt flow | Oxygen | | Mass |
|---|---|---|---|---|---|
| | viscosity | index | transmittance rate | | reduction |
| | (Pa · s) | (g/10 min) | g/m² · day | g · μm/m² · day | rate (%) |
| Example 1 | 2,040 | 57 | 0.52 | 109.2 | 45 |
| Example 2 | 4,365 | 36 | 0.65 | 156.0 | 26 |
| Example 3 | 12,987 | 15 | 0.94 | 206.8 | 9.8 |
| Example 4 | 4,523 | 31 | 0.91 | 209.3 | 10 |
| Example 5 | 1,523 | 67 | 0.38 | 83.6 | 70 |
| Comparative | 28,450 | 6 | 1.20 | 252.0 | 7.9 |
| example 1 | | | | | |
| Comparative | 1,776 | 54 | 1.00 | 210.0 | 7.2 |
| example 2 | | | | | |
| Comparative | 7,885 | 20 | 72.4 | 15,928 | 2.2 |
| example 3 | | | | | |
| Comparative | 23,225 | 9 | 65.9 | 13,180 | 1.9 |
| example 4 | | | | | |
| Comparative | 3,384 | 28 | 63.3 | 13,293 | 1.9 |
| example 5 | | | | | |
| Comparative | 16,730 | 9 | 147.0 | 32,340 | 1.2 |
| example 6 | | | | | |
| Comparative | 105 | 135 | 0.48 | 120.0 | 99 |
| example 7 | | | | | |
| Comparative | 10,523 | 6 | Exceeded | Exceeded | 0.2 |
| example 8 | | | | | |
| Comparative | 1,685 | 12 | Exceeded | Exceeded | 0.3 |
| example 9 | | | | | |

Referring to Table 2, examples including PLGA, zinc-containing ionomer and ethylene copolymer, and in which the content of PLGA is 65 wt % or more based on the total weight of the poly(lactic-co-glycolic acid)-containing resin composition, exhibited oxygen transmittance rate of less than 1.0 g/m²·day.

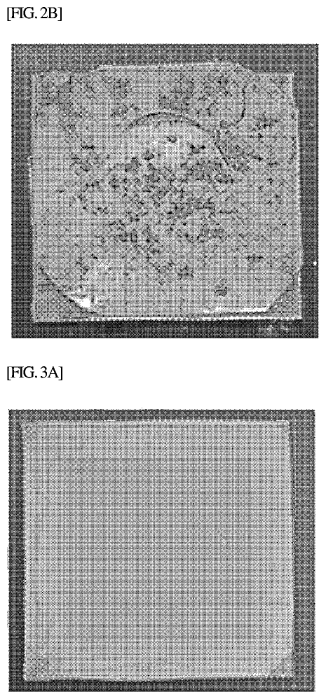

FIGS. 2A and 2B are a photograph of a film according to Example 3 and a photograph illustrating a degree of biodegradation when the film is left in soil under composting conditions, respectively. Referring to FIGS. 2A and 2B, and Table 2, when PLGA is included in an amount of 65 wt % based on the total weight of the poly(lactic-co-glycolic acid)-containing resin composition, partial biodegradation occurred while the low oxygen transmittance rate of the film was maintained low.

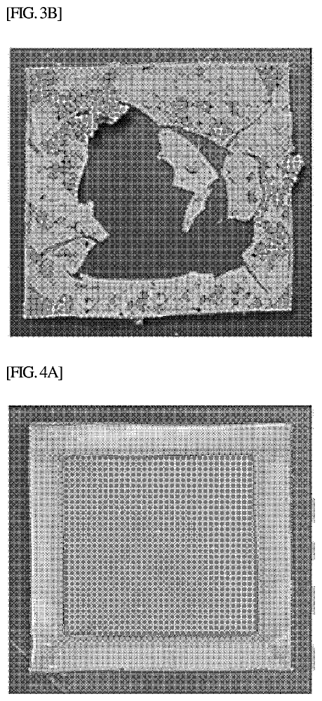

FIGS. 3A and 3B are a photograph of a film according to Example 5 and a photograph illustrating the degree of biodegradation when the film is left in soil under composting conditions, respectively. Referring to FIGS. 3A and 3B, and Table 2, when PLGA was included at 90 wt % based on the total weight of the poly(lactic-co-glycolic acid)-containing resin composition, the oxygen transmittance rate of the film was slightly reduced and the biodegradability was slightly increased.

In Comparative Example 1 where a film which did not include a zinc-containing ionomer was used, the melt viscosity was increased, and a partially non-melted portion was found.

In Comparative Example 2 where a film which did not include an ethylene copolymer was used, phase separation between the PLGA and the zinc-containing ionomer occurred.

In Comparative Examples 3 to 6 where the PLGA content was 60 wt % or less based on the total weight of the poly(lactic-co-glycolic acid)-containing resin composition, the oxygen transmittance rate was increased.

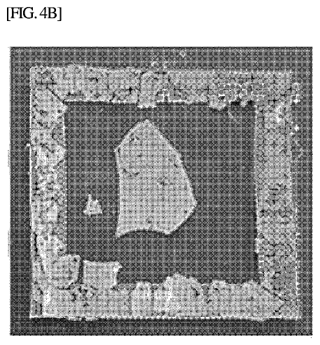

FIGS. 4A and 4B are photographs illustrating the degree of biodegradation of a film according to Comparative Example 7 and the film when left in soil under composting conditions, respectively. Referring to FIGS. 4A and 4B, and Table 2, the biodegradability of the film was increased excessively.

In Comparative Examples 8 and 9 which did not include PLGA, the oxygen transmittance rate was increased.

What is claimed is:

1. A resin composition comprising poly(lactic-co-glycolic acid) (“poly(lactic-co-glycolic acid)-containing resin composition”), the resin composition comprising:
a poly(lactic-co-glycolic acid) (PLGA) polymer;
a zinc-containing ionomer; and
an ethylene terpolymer,
wherein the PLGA polymer is 65% by weight or more and less than 100% by weight based on a total weight of the poly(lactic-co-glycolic acid)-containing resin composition.

2. The resin composition according to claim 1, wherein the zinc-containing ionomer comprises a terpolymer of ethylene, zinc (meth)acrylate and (meth)acrylic acid.

3. The resin composition according to claim 1, wherein the ethylene terpolymer comprises a copolymer of ethylene, glycidyl (meth)acrylate and alkyl (meth)acrylate.

4. The resin composition according to claim 1, wherein a content of the PLGA polymer is 65% by weight to 98% by weight based on the total weight of the poly(lactic-co-glycolic acid)-containing resin composition.

5. The resin composition according to claim 1, wherein a content of the zinc-containing ionomer is 1% by weight to 34% by weight based on the total weight of the poly(lactic-co-glycolic acid)-containing resin composition.

6. The resin composition according to claim 1, wherein a content of the ethylene terpolymer is 1% by weight to 34% by weight based on the total weight of the poly(lactic-co-glycolic acid)-containing resin composition.

7. The resin composition according to claim 1, wherein a sum of the content of the zinc-containing ionomer and the content of the ethylene terpolymer is 2% by weight to 35% by weight based on the total weight of the poly(lactic-co-glycolic acid)-containing resin composition.

8. The resin composition according to claim 1, wherein a content of the ethylene terpolymer is the same as the content of the zinc-containing ionomer or more in the total weight of the poly(lactic-co-glycolic acid)-containing resin composition.

9. The resin composition according to claim 1, wherein a melt viscosity of the poly(lactic-co-glycolic acid)-containing resin composition measured under conditions of 230° C., 5% strain, and 0.1 Hz frequency is 500 Pa·s to 20,000 Pa·s.

10. The resin composition according to claim 1, wherein a melt flow index of the poly(lactic-co-glycolic acid)-containing resin composition measured under conditions of 230° C. and 2.16 kg load is 1 g/10 min to 100 g/10 min.

11. A film formed from the resin composition comprising poly(lactic-co-glycolic acid) of claim 1.

12. The film according to claim 11, wherein the film has a thickness of 100 μm to 300 μm.

13. The film according to claim 12, wherein an oxygen transmittance rate of the film measured at a relative humidity of 0% and a temperature of 25° C. is 50 g/m²·day or less.

14. The film according to claim 11, wherein a mass reduction rate of the film calculated according to Equation 1 below is 5% to 85%:
$$Mass reduction rate ( \% ) = \frac{{W}_{i} - {W}_{f}}{{W}_{i}} \times 100 \qquad [ Equation 1 ]$$
(in Equation 1, Wᵢ is an initial mass (g) of the film, and W_{f} is a mass (g) of the film measured after the film is left in soil under composting conditions according to ISO 20200 for 6 months).

15. The film according to claim 11, wherein an oxygen transmittance rate of the film satisfies Equation 2 below:
$$OTR ( PLGA - Poly ) < 0.1 ( x \cdot OTR ( PLGA ) + ( 1 - x ) \cdot OTR ( Poly ) ) \qquad [ Equation 2 ]$$
(in Equation 2, OTR (PLGA-Poly) is the oxygen transmittance rate of the film formed from the poly(lactic-co-glycolic acid)-containing resin composition, OTR (PLGA) is an oxygen transmittance rate of a film including only poly(lactic-co-glycolic acid), OTR (Poly) is an oxygen transmittance rate of a film including only a resin including a zinc-containing ionomer or an ethylene terpolymer, and x is in a range of 0.65≤x<1).

16. The film according to claim 11, wherein the film is formed using a press maintained at a temperature of 200° C. to 260° C. and a pressure of 10 MPa to 30 MPa for 1 minute to 3 minutes.
